(19) United States
(12) Patent Application Publication
(10) Pub. No.: US 2014/0244400 A1
(43) Pub. Date: Aug. 28, 2014

(54) SYSTEMS AND METHODS FOR SOCIAL ADVERTISEMENT SYNDICATION

(71) Applicant: CitizenNet Inc., Culver City, CA (US)

(72) Inventors: Daniel Benyamin, Los Angeles, CA (US); Michael C. McGinley, Los Angeles, CA (US); Michael Aaron Hall, Valencia, CA (US); Nicholas J. Bina, Los Angeles, CA (US)

(73) Assignee: CitizenNet Inc., Culver City, CA (US)

(21) Appl. No.: 14/255,658

(22) Filed: Apr. 17, 2014

Related U.S. Application Data
(63) Continuation of application No. 12/467,981, filed on May 18, 2009.
(60) Provisional application No. 61/178,619, filed on May 15, 2009.
(60) Provisional application No. 61/054,074, filed on May 16, 2008.

(51) Int. Cl. G06Q 30/02; G06Q 50/00

(52) U.S. Cl. CPC G06Q 30/0269; G06Q 30/0274; G06Q 50/01
USPC 705/14.66

(57) ABSTRACT

Systems and methods for syndicating advertising content are described. In one embodiment, a method of syndicating relevant user activities includes obtaining a first advertising bid from a first advertising site, obtaining a second advertising bid from a second advertising site, recording user activities with a first participating site, classifying the recorded user activities describing at least one category associated with the recorded user activity, determining an auction strategy based on the first advertising bid, the second advertising bid, the first advertising site, and the second advertising site, where the auction strategy selects at least one winning advertising site, generating an ad unit ad unit including metadata describing the recorded user activity and the at least one winning advertising site, and syndicating the generated ad unit to at least one participating site within an advertisement network.

### CROSS REFERENCE TO RELATED APPLICATIONS

This application is a continuation of U.S. patent application Ser. No. 12/467,981, filed May 18, 2009, that claims the benefit of U.S. Provisional Patent Application Ser. Nos. 61/054,074, filed May 16, 2008 and 61/178,619, filed May 15, 2009, the disclosures of which are hereby incorporated by reference in their entirety.

### FIELD OF THE INVENTION

The present invention generally relates to online advertising and marketing networks and in particular to advertising and marketing social networks utilizing user activities.

### BACKGROUND

Social networks, such as MYSPACE and FACEBOOK, are frequently visited web sites with a large average stay time. People enjoy communicating and connecting with like-minded friends, and these well-publicized networks help fill this need. Traditional online marketing techniques, however, are proving to be ineffective on such large social web services. Large social networks do not help expose the commercial intent intrinsic to either source, and thus become poor vehicles for targeted advertising. In parallel to this, when consumers search they are increasingly drawn to non-retail sites when shopping, and search results against product research queries increasingly reach user generated content.

In addition, as one's online social connectedness grows the majority of one's online “friends” tend to be more approximately described as acquaintances. For marketers, social graphs of this extent indicate little about their target audience, and even less about an individual's capability as a word-of-mouth influencer. Furthermore, even more challenging than understanding a user's social affiliations is trying to find any marketing-worthy conversations.

Accordingly, with the failure of traditional marketing techniques for social networks and the increasing draw of consumers to non-retail sites, there is a need to provide systems and methods to capture and capitalize user activities that is marketing-worthy and relevant to a product search and to a consumer's social affiliations. In such a way, a mutually beneficial system for users providing activities, retailers promoting products through such activities and publishers/syndicators displaying or supplying such activities can be established.

### SUMMARY OF THE INVENTION

Generally, activity systems and methods for social networks are provided. In one embodiment, a method of supplying relevant user activities of a social network is provided. The method comprises classifying user activities by an activity server coupled to a network; and matching the classified user activities by the activity server to a search query based on a matching criteria.

In another embodiment, an activity system for supplying relevant user activities of a social network is provided that comprises a plurality of servers gathering user activities and an activity server in network communication with at least one of the plurality of servers. The activity server is also configured to classify the user activities from the at least one of the plurality of servers and to match the classified user activities to a search query received from at least one of the plurality of servers based on a matching criteria.

The above-mentioned and other features of this invention and the manner of obtaining and using them will become more apparent, and will be best understood, by reference to the following description, taken in conjunction with the accompanying drawings. The drawings depict only typical embodiments of the invention and do not therefore limit its scope.

### BRIEF DESCRIPTION OF THE DRAWINGS

FIG. 1 illustrates an overview of an activity network in accordance with various embodiments of the present invention.

FIG. 2 is a flow diagram providing an overview operation of registering a website/web server in accordance with various embodiments of the present invention.

FIG. 3 is a flow diagram providing an overview operation of registering a user in accordance with various embodiments of the present invention.

FIG. 4 is a webpage view displaying user activities in accordance with various embodiments of the present invention.

FIG. 5 is a flow diagram of the characterization and syndication of user activities in accordance with various embodiments of the present invention.

FIG. 6 is a webpage view/message post displaying user activities in accordance with various embodiments of the present invention.

FIG. 7A is an instant message view displaying user activities in accordance with various embodiments of the present invention.

FIG. 7B is a webpage view displaying user activities including a multimedia activity in accordance with various embodiments of the present invention.

FIG. 7C is a webpage view displaying advertisements linked with user activities in accordance with various embodiments of the present invention.

FIGS. 7D-7G are webpage views displaying user activities including a multimedia activity in accordance with various embodiments of the present invention.

FIG. 8 is a webpage view displaying user activities and a user registration entry point in accordance with various embodiments of the present invention.

FIG. 9 is a webpage view displaying a user registration entry point in accordance with various embodiments of the present invention.

FIG. 10 is a webpage view of user activities in accordance with various embodiments of the present invention.

FIGS. 11-12 are webpage views of user interfaces managing propagation or syndication of a user's activities in accordance with various embodiments of the present invention.

FIG. 13 is a flow diagram of an activity network process in accordance with various embodiments of the present invention.

FIG. 14 is a flow diagram of an activity network process in accordance with various embodiments of the present invention.

FIG. 15 is a block diagram of an activity network in accordance with various embodiments of the present invention.

FIG. 16 is a block diagram of an activity network in accordance with various embodiments of the present invention.

FIG. 17 is a flow diagram illustrating a messaging/activity classification generation process in accordance with various embodiments of the invention.

FIG. 18 is a flow diagram illustrating a messaging/activity classification retrieval process in accordance with various embodiments of the invention.

### DETAILED DESCRIPTION

### Overview

Generally, an activity system is provided that cross-promotes the activities of users on web sites. A participating user on a participating web site can syndicate their selected activities to various other participating sites through an activity server of the activity system. The activity server acts as the central hub to the participating sites to propagate their participating users' activities. These activities can include but are not limited to purchases, reviews, and postings. The activity server in one embodiment includes a message classifier that scores and categorizes each activity for one or more categories in which the activity server can match with a given search query to provide publishing sites the most relevant activities for each site. In various embodiments, the activity server includes a message optimizer that refines the search results provided by the message classifier to further provide publishing sites a finer selection of activities for each site. The activity system in one embodiment provides an auction system in which advertisers sponsor activities, and the sponsorship fee is split between sites that originate content, sites that display the content, and the activity system.

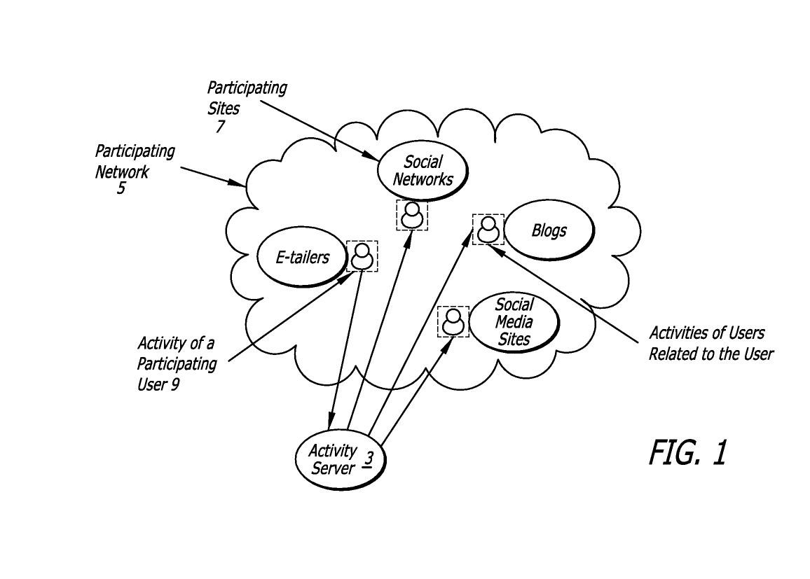

In FIG. 1, an activity network includes an activity server 3 connected to a plurality of web servers via the Internet. The plurality of web servers is abstractly grouped into a participating network 5 with each web server or site being a participating server 7. A particular user of the participating server is a participating user 9. The activity server 3 collects participating user activity data provided from various participating servers to determine which user activities should be published, when, and to which websites.

Each participating server operating with the activity server 3 has an advertising agreement or service key in which an Application Protocol Interface (API) is integrated with the services provided by each web server. In addition, the participating server may have its own API, such as TWITTER or FACEBOOK, in which case the activity server complies with this published API and its privacy logic. Each participating user of the participating server in turn can choose to participate in the activity server operations, which will be discussed in greater detail below, through the participating server. When a user chooses to participate, some or all activities of the user are propagated and promoted throughout other participating web sites in the participating network.

Activities can be varied and are largely communications generated by participating users or as a result of actions performed by the user on a participating website. The activities in one embodiment can be grouped according to a specific medium, e.g., social networks or blogs, as well as communication types, e.g., reviews or posts. For example, retail sites can provide user activities of products bought, users showing an interest in a product or other similar product or retail related communications. Social networking sites can provide user activities of adding comments, creating events, profiles, tagging, sharing media, posting, joining groups and other similar social interactions. The following is a list of other potential activities provided for exemplary purposes and it should be appreciated that there can be additional activities and that all such activities are not required to practice the invention. In accordance with various embodiments, activities could include Reviews (found review helpful, answered questions, rated); Chats (who a user chatted with, what rooms have a user been in, added friend to friends list); Forums (wrote in new blog, tracked thread, made friend, subscribed to thread, commented on, tracked person); Blogs (posted to blog, commented on blog, subscribed to, added friend of blog, media played, bought, downloaded, rated song); gaming/console activities (achieved some achievement, beat some game, joined some group/guild, played game, attached/bought a new peripheral); and television activities (recorded show, watched show, rated show). One would also appreciate that the subject of the activity may be more important than the activity itself. For example, if the activity is “Dan is watching a video,” what may be more interesting is the subject, i.e., the contents of the video (what video Dan is watching).

### Registration of Site/Server to be a Participating Site

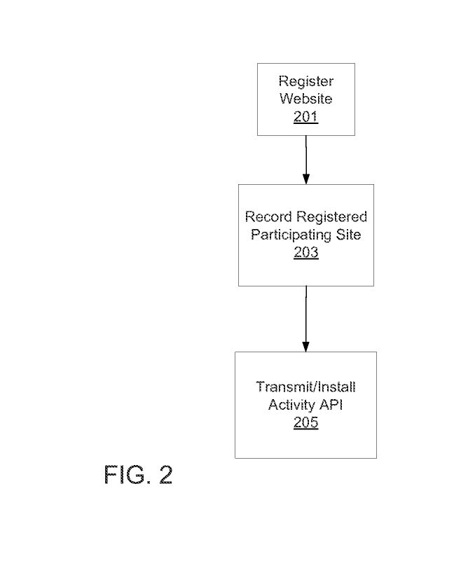

In FIG. 2, a web server registers with the activity server (201) and becomes a participating server. The activity server records the registration in a server database (203) and provides activity application programming interface (API) to the registered web server (205). The activity API continues to operate on the participating server until terminated by the activity server or the participating server.

### Registration of a User to be a Participating User

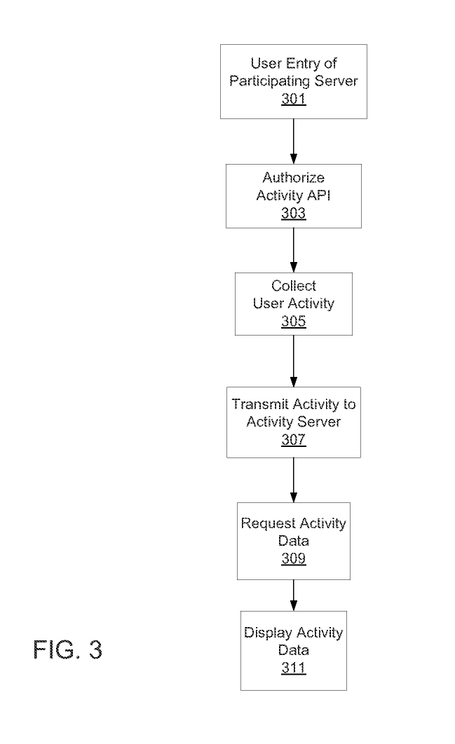

Referring to FIG. 3, the participating server provides one or more access points or interfaces for an existing or new user (301). Through one or more of these interfaces, a new or existing user of the participating server authorizes or permits use of the activity API for the particular user (303). For example, during a registration interface of a new user, the new user is provided an option to authorize use of the activity API. Upon authorization, activity data of the new user is collected by the activity API (305) and is supplied to the activity server (307). In one embodiment, the integrated activity API indicates when a new user signs up, logs the activities the user participates in, and when a user links or otherwise associates themselves with another user. The supplied data to the activity server, unless otherwise requested by the user, is anonymous and not personally identifiable. The data is supplied immediately from the participating server to the activity server or through predetermined periodic updates. The integrated API also requests and receives activity data, e.g., related user activity from other participating sites, supplied from the activity server (309). The integrated API displays or supplies the activity data to the participating server to display the user activity on the participating site (311). In one embodiment, instead of registering through the integrated API, the user registers to be a part of a third party service in which the activity server then plugs into the third party service's API.

### Displaying User Activities at a Participating Site

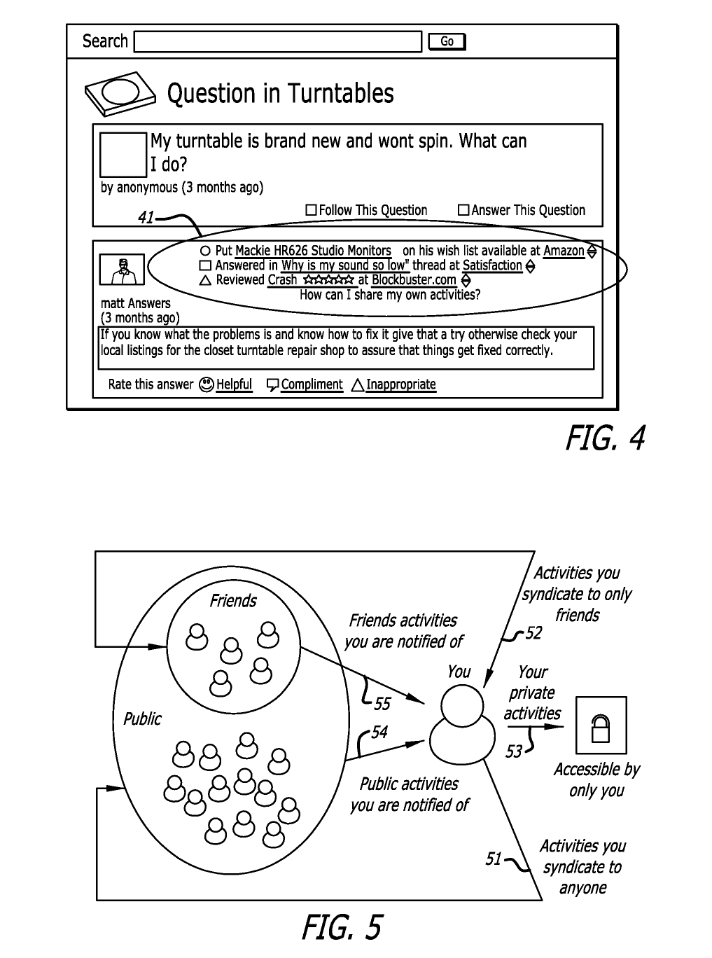

Referring now to FIG. 4, a user “matt” has provided an answer to a question posted on a consumer website, the consumer website being a registered participating web server. In addition to the answer, activities by the user “matt” are placed right inside the post (reference circle 41) providing an insight into Matt's other activities. The posted activities provide additional information related to the posting, or an unrelated activity, e.g., a serendipitous activity that is fun for his friends to see. The posted activities are supplied by the activity server through the integrated activity API of the participating site.

In one embodiment, an activity from a syndicating site matches or corresponds to the content or frame of reference for the publishing site, e.g., a consumer website. Activities of other users other than user “matt” can be displayed along with the activities of user “matt.” Such activities may be highlighted, distinguished, or identified in such a way so as to distinguish activities of user “matt” versus activities of other users. If the syndicating other user is not a registered user, then the activity can be displayed in an anonymous fashion subject to the privacy terms of the syndicating site. When an anonymous activity is selected, a user is directed to an anonymous landing webpage. For example, if a user comments on a video and is not a registered user, any other user selecting this activity will be directed to the video, not to the unregistered user's comment.

The frequency and placement of an activity on a particular participating site is a function of several attributes. Some attributes include, but are not limited to, the age of the activity (e.g., newer activities get higher placement), the contextual relevance of the listed activity to the current activity or page, the viewing user has voted for that type of activity, how much the syndicating user has promoted this type of activity and the historical relationship between the viewing and receiving or syndicating users.

In one embodiment, the activity server determines the specific activities to be displayed, but the visualization of the activity is specified by the publishing site or server. In addition, the publishing server may communicate certain activity preferences to the activity server via the activity API. The participating site in one embodiment is given a range of display options to choose from. In various embodiments, the activity API of the participating site specifies a JavaScript program to be embedded in the web page served by the publishing site. The JavaScript is responsible for querying the activity server and rendering the results on the web page.

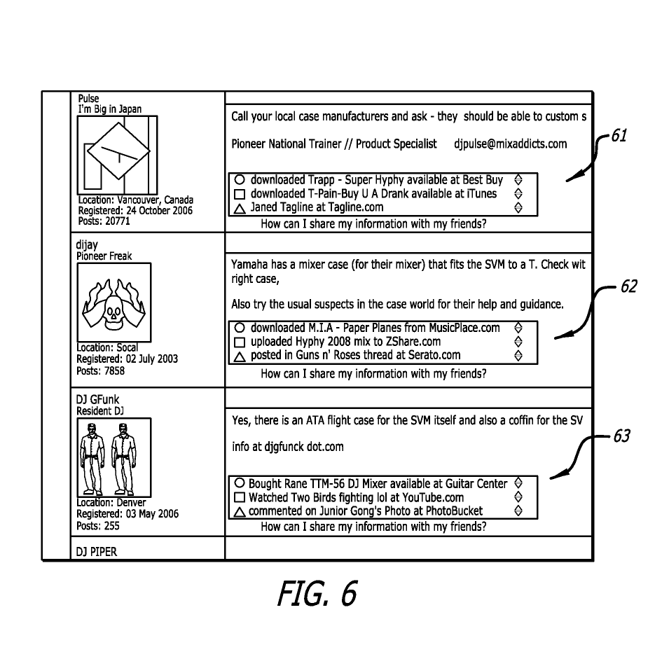

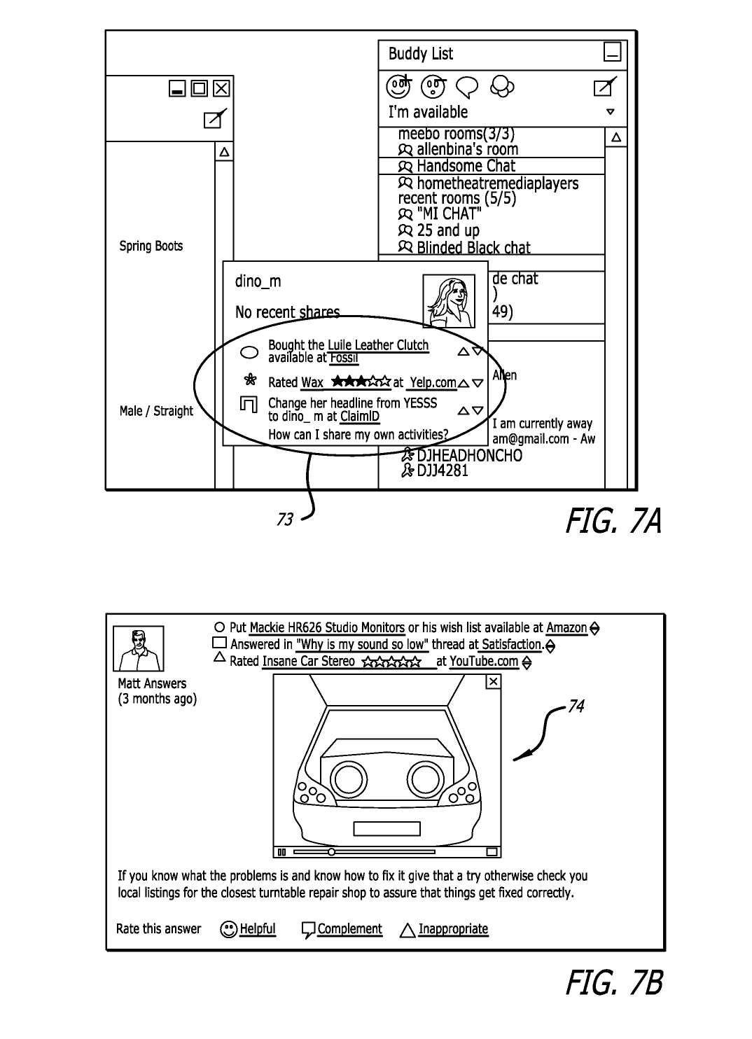

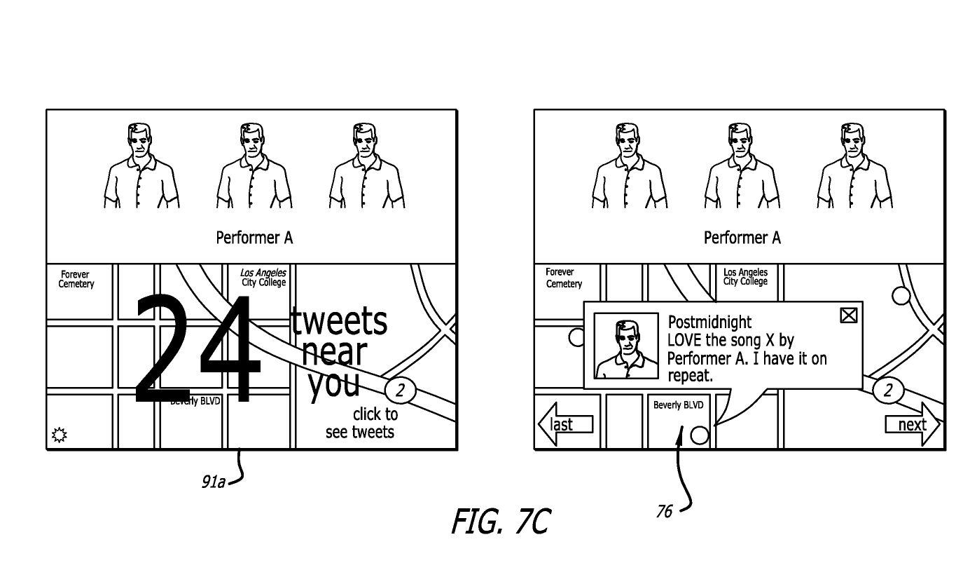

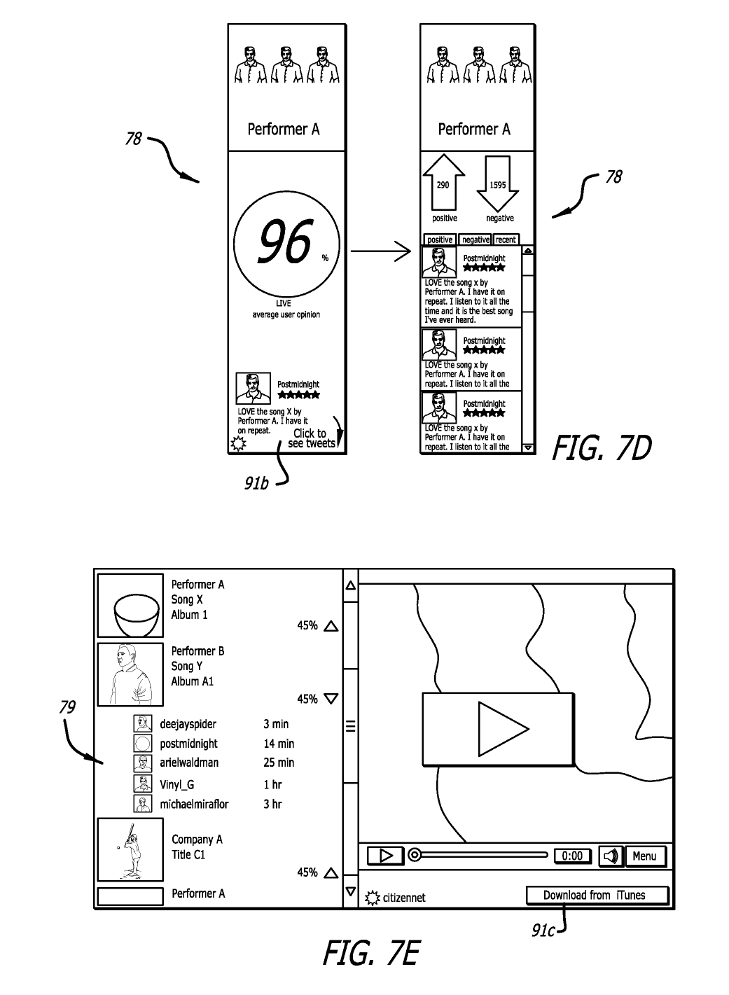

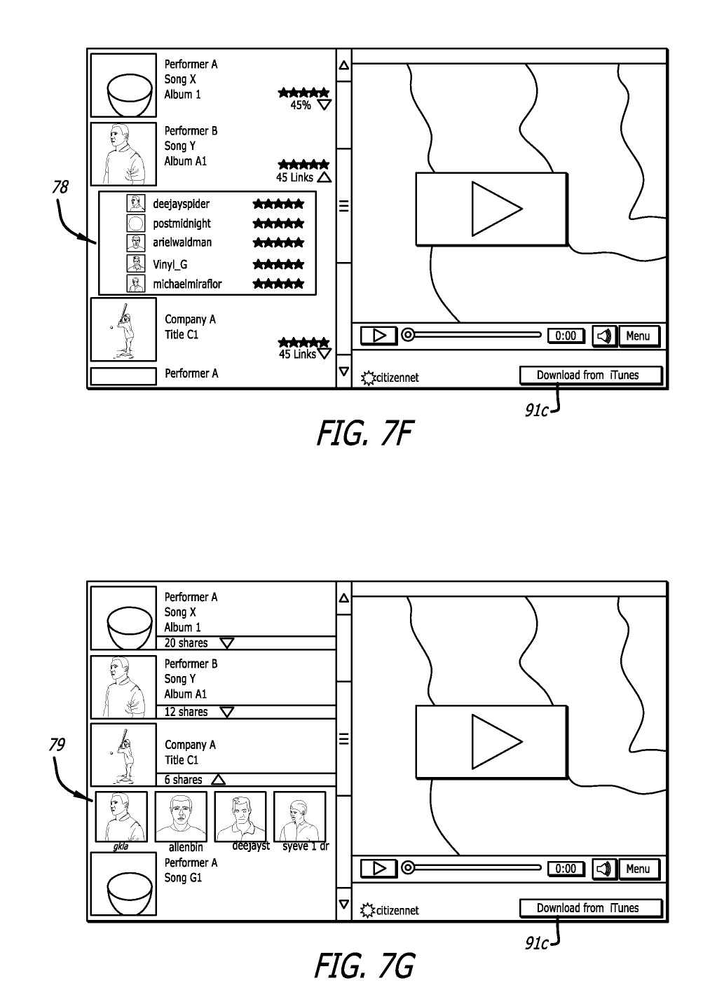

When browsing the pages of a participating site, a user will see both public and friend activities wherever it is appropriate for the service. FIG. 6 illustrates a message board that contains three activity units (61, 62, 63) related to each individual message and the user who has posted the message. FIG. 7A shows user activity data 73 being displayed through a web-based instant messaging service. Here, by placing the mouse over the user's name, a pop up appears with the user's profile information and recent activities. The activities may also appear directly in the conversation.

Rather than simply linking to content, certain activity units can embed the desired information, e.g., multimedia content, directly in the activity unit. For example, in FIG. 7B, a video playback box 74 is displayed directly below an activity descriptor that corresponds to the activity provided by a syndicating site. The video playback box may appear only when the user engages with the activity unit (via a mouse roll over, for example), and may be subject to the licensing terms of the syndicating site. Also, any appropriately sized amount of content can be presented, including streaming audio, interactive content, and still images. In addition to or in the alternative to embedding content, the activity unit can offer commercial transaction capabilities, for example, a “shopping cart” capability embedded directly into the activity unit.

As shown in FIGS. 7C-7G, the aggregation of activities may be grouped in a number of different ways. For example, groupings can include the raw number of users performing an activity 79, the rate of change of users doing the activity 77, the opinion of people expressed in the activity 78, or people nearby a locale 76. Also, a paid link from an existing advertisement network that is contextually related to keywords provided by the published activities can also be included. For example, in FIGS. 7E-7G, the paid link (“Download from iTunes” link 91c) that is matched with the activity and the page is shown. The paid link may also be a “buy” button 91a (FIG. 7C), a big banner ad 91b (FIG. 7D) or other similar user selectable objects. FIGS. 7C-7D also represents advertising units, e.g., advertisements paid by advertiser, in which the advertisement matches the content on the page and with the item for sale being the subject of the advertisement. As such, in the illustrated cases, the user activities or messages displayed are reviews or comments that relate directly to the performers and/or the multimedia content, e.g., the video/audio file.

### Existing User on a Participating Site Becoming a Participating User

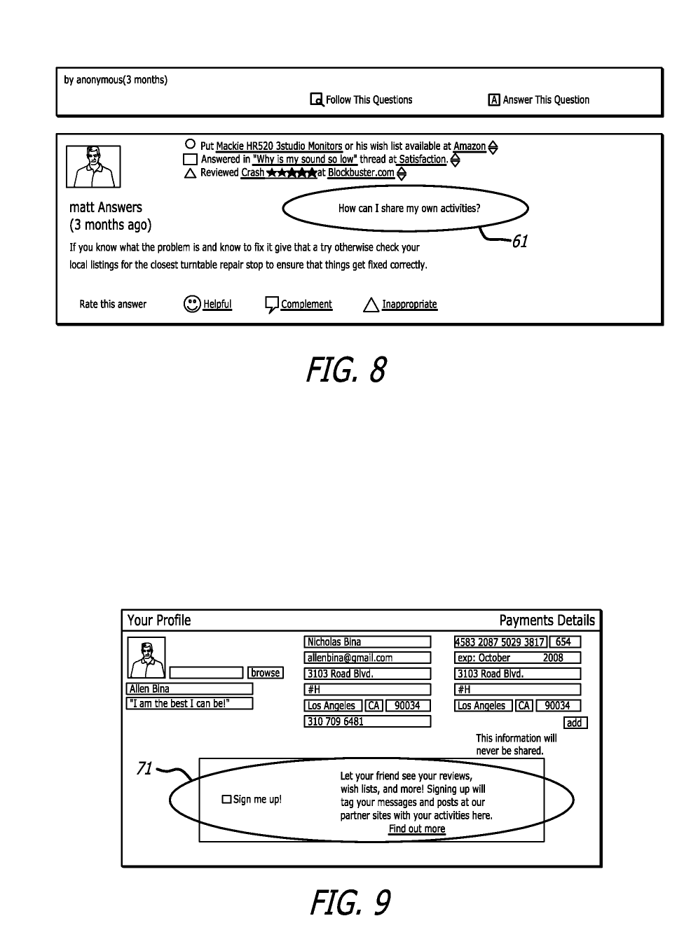

Referring to FIG. 8, in one embodiment, a participating server includes a link or access to the activity API for existing users or users that originally did not authorize use of the API. For example, a link such as “How can I share my own activities” (reference circle 61) provides users an entry access point into the API to authorize the API to make their user activities available.

FIG. 9 illustrates another example of providing a user entry point to become a participating user and thus propagate their activities to other participating sites. The circled area 71 highlights a check box, which once checked permits a user to opt into the service and thus authorize operation of the activity API. The service is positioned as a way for users to help tell their friends about the actions they do on this site. It also draws attention to the posts, reviews, images and anything else one would do publically online.

### User Control Over Syndicated Activities

As depicted in FIG. 5, the user can also choose how the activity data is propagated, e.g., available to anyone (activities you syndicate to anyone 51); available to friends only (activities you syndicate to only your friends 52); or strictly private (your private activities 53 accessible only by you). Likewise, public activities 54 can be provided to the user as well as friends activities 55. In various embodiments, the privacy controls are set in place by the participating site's API.

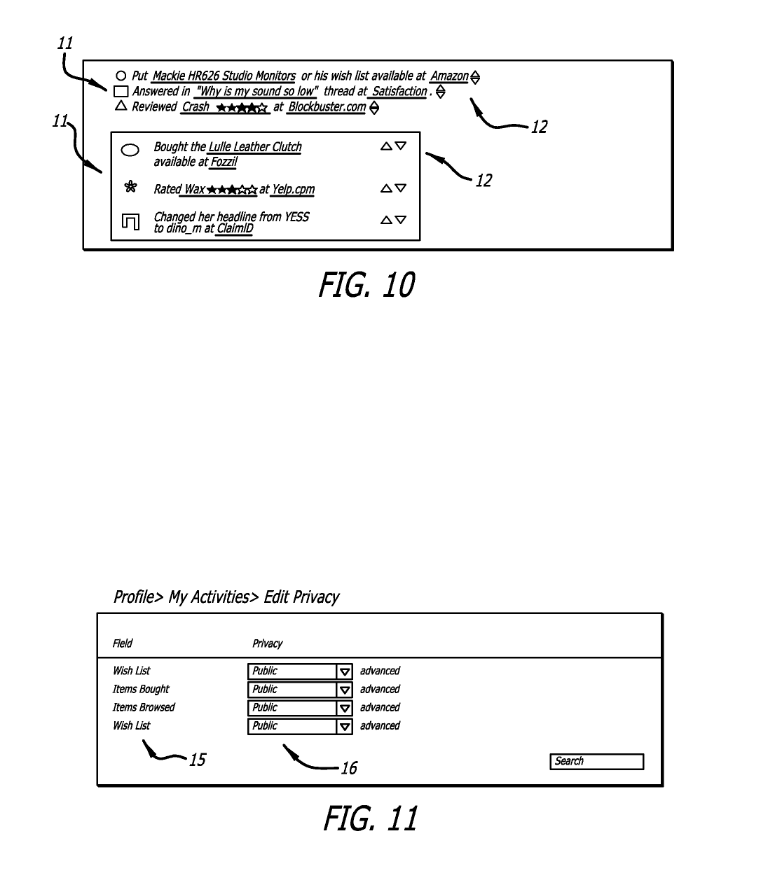

Referring now to FIG. 10, various user activities are recorded by the activity API of a participating site and thus provided to the activity server. The activity server supplies this activity data to other participating sites. The users on the receiving participating sites are exposed to this activity data as indicated by the original user. The activity data can vary. For example, the activities can occur between things that are contextually relevant to the current page, to those that are relevant to the affinity between the user viewing the page and the user whose activities are displayed.

The receiving user can also vote or emphasize the user's affinity or relevance for a particular activity. For example, the small arrows 12 next to each activity 11 allow the user viewing the page to vote on their desire to see that type of activity. For example, if the user enjoys reading reviews from a particular participating site, that activity can be voted higher. On the other hand, if not the activity can be voted downwards. As such, future activities that resemble the low voted activity can be discarded, e.g., not provided to the user.

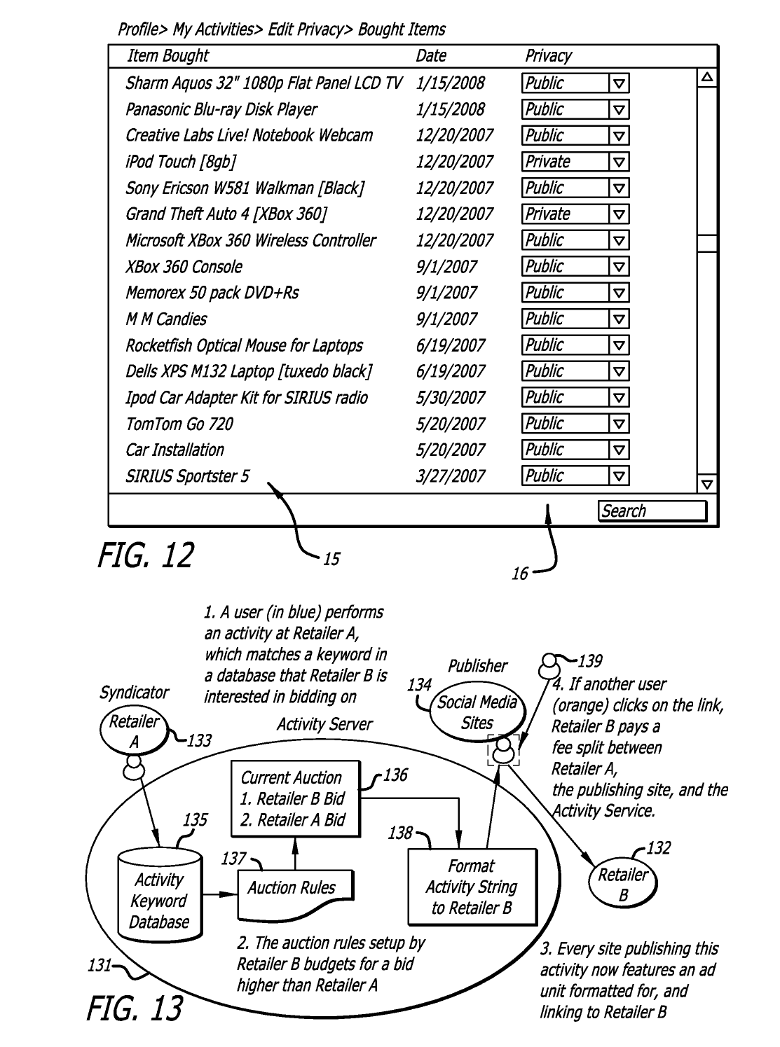

The participating users at the participating sites may also control or manage the activities that can be viewed by other participating users. For example, in FIG. 11, through an account preferences page at the participating site, a participating user controls the types of activities 15 and who gets to view them 16. For each type of activity, the user has the choice to make the activity public, public only to friends, or to keep private. FIG. 12 provides another example of providing a participating user to fine tune their preferences. Each activity is initially set to private and allows users to select which activity to make public.

In one embodiment, with the user deciding which activities can be propagated, three activity data sets can be identified. The first data set includes all of the user activities. The second data set includes user activities that the user would like his/her friends to view (restricted—some defined criteria associated with the receiver of the data). The third data set includes user activities that the user would like to be public (unrestricted). The activity server receives all activities from participating sites except private activities. All of the data accepted into the activity server is stored (e.g. in a log, database, and so on). When a page is viewed at a participating publishing site, the activity server will choose which activity in the database is most appropriate for display. It is the responsibility of the activity server to filter/organize the information appropriately. It is filtered based on many pieces of criteria, such as the time of activity, the user who performed the activity, the site that originally captured the activity, the activity type, the object type, keywords in the body of the activity, the relationship between the viewing and the syndicating users, the type of service provided by the participating server (retail versus a blog), user or server profile, request for specific activity data, and/or a winning bid server.

### Activity Identifiers and Links

In one embodiment, the wording (how an activity is presented or described) and the linking of the activity is bundled as an activity unit by the activity server. The activity unit is auctioned to advertisers. For example, each activity is auctioned to all advertisers with appropriate activity keywords. If an advertiser was the source of the original activity (the syndicator), they are offered a discount to the current auction price (this discount does not affect the auction ranking). The winning advertiser is featured in the activity. If a user then clicks on the activity, it leads to the winning advertiser upon which the winning advertiser pays the winning auction amount to the activity server. The activity server pays a portion to the site hosting the activity, e.g., a referral fee. If the winning advertiser is not the syndicator, the syndicator receives a portion of the click cost that is paid by the winning advertiser. As such, these activities can form the basis of a cost per click (CPC) advertising model, in which sites that originate content pay a fee to those that display the content with the entity that maintains the activity server taking a portion of this fee.

In one example, a user “Dan” is viewing a forum and sees that another user “Allen” has purchased a new video card. The actual purchase was made at a retailer site, “Retail One.” “Retail Two” posts the highest bid for this activity, and “Retail One” is provided with an offer to win the auction at a discount to “Retail Two's” bid. If “Retail One” wins this bid, the activity can be displayed or identified as “Allen has purchased a new R1 video card from Retail One.” If a user clicks on the link provided with the displayed activity, “Retail One” pays the activity server, which in turn pays a portion to the forum.

If, on the other hand, “Retail Two” wins the bid, the activity can be displayed or identified as “Allen has purchased a new R1 video card, available at “Retail Two.” If a user clicks this link, “Retail Two” will pay the activity server, which in turn pays a portion to the forum and to “Retail One.” In addition to the above rules, a minimum bid is set for each activity per user. The value is a function of the type of activity, as well as the effectiveness of the user as a user to influence others. It should be appreciated that not all activities will be sponsored, and non-sponsored activities may be displayed if they are a good match to the publishing site. If a user clicks on a non-sponsored activity, it simply becomes a link and no money is exchanged. The paid link as previously noted may also be a “buy” button, a big banner ad or other similar user selectable objects.

Referring to FIG. 13, the activity server 131 in one embodiment includes but is not limited to a combination of three independent services or networks: an advertising network, a syndication network and an activity/advertising inventory server. The advertising network is passive, whereby a website acts as an advertiser based on the activities of users on other sites. Budgets can be created on a CPC basis using a combination of keywords. In illustrated example, Retailer B 132 only participates as an advertiser. The syndication network syndicates the activities of a site's users to the network. These activities form links back to the activity on the originating website, unless they are outbid by another participating site. Retailer A 133 utilizes the network to syndicate their user's activities to all the publishing sites. The activity/advertising inventory server provides an inventory of activities and matches them with the users on a website. In this scenario, the website becomes the publisher of the syndicated activities. Social Media Sites 134 publish the information syndicated to them from the network in which the activities operate as advertisements when a user clicks on the activity. Many sites can benefit as both a publisher as well as a syndicator. A site could syndicate out all activities, and publish activities from other sites. In one embodiment, a site can choose to publish only paid links such that a portion of the CPC price for every click made is earned by the publishing site.

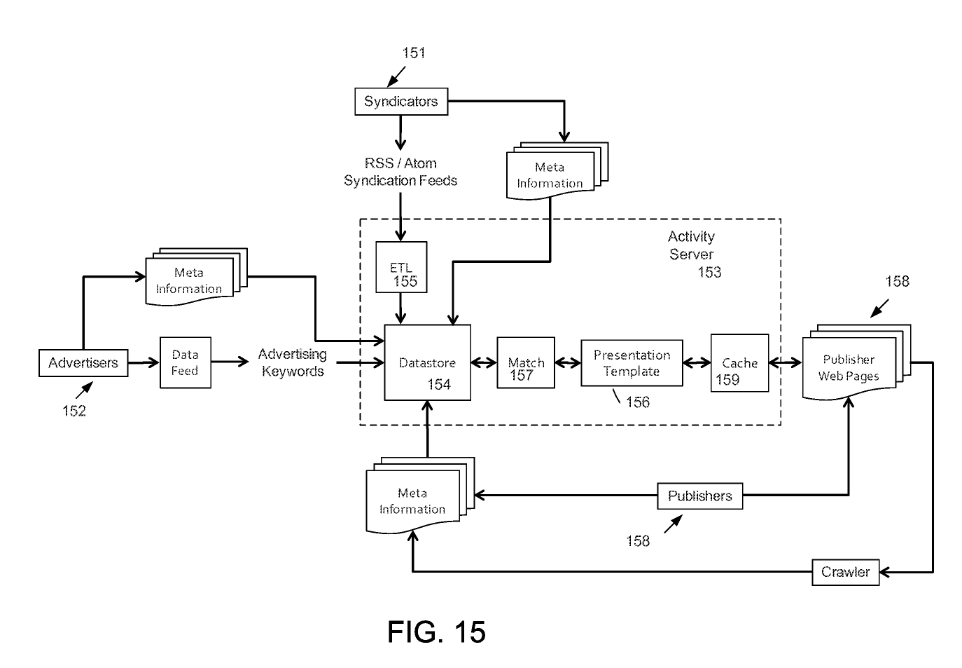

In the illustrated example of FIG. 15, a user performs an activity at Retailer A 133 that matches a keyword in an activity keyword database 135 of the activity server 131 that Retailer B 132 is interested in bidding on. Both Retailer A and Retailer B provide bids for the auction 136. In one embodiment, the auction rules 137 setup by Retailer B budgets for a bid higher than Retailer A. By successfully winning the auction, the activity server 131 formats an activity string or unit 138 for Retailer B. As such, every site publishing this activity now features an advertising unit formatted for and linking to Retailer B. If another user 139 clicks on the link, Retailer B pays a fee split between Retailer A, the publishing site and the Activity server or service.

In one embodiment, a non-advertised publisher, e.g., a website that depends on or only contains user-generated content, may desire additional content. Such a site can register with the activity server to publish content that matches their site's needs or audience. The content published can be non-advertised, in which case the site would register with the activity server to directly gain access to the syndicated information. Such access could be a subscription based fee arrangement for the information or a discrete pricing fee for the specific or selected syndicated information.

In one embodiment, the activity network can provide a platform for other services. The services can be built either internally or by third parties via an API. One service is a unified registration and online identity provider, unifying the registration and syndication of information to a number of sites. This can be both a convenience to users as well as a way for new sites to draw new registrations. In one embodiment, an activity feed service can also be provided. A user can establish a central location where all their activities and their friends' activities are published which is fed by the activity server.

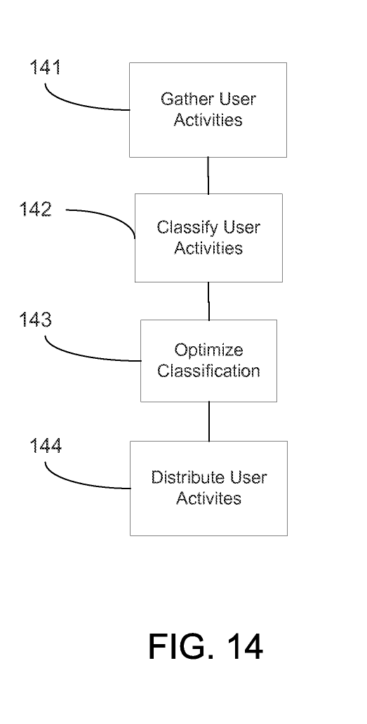

Referring now to the process shown in FIG. 14, the activities of participating users are collected by the activity server (141). The activity server includes one or more subject matter categories in which the information for the activities are stored. A message classifier integrated with or coupled to the activity server selects which activity to associate with each category (142). The message classifier also computes a message or activity score for each category. In this way, the message classifier can determine a score or ranking for each activity relative to the category with the higher ranked activities being the most relevant to the given category. With each activity scored and categorized, the activity server can search and find activities relevant to a user, an advertiser, a publisher, and/or a syndicator. The search results are then distributed by the activity server (144).

In one embodiment, a message classifier is provided in which categories are set up with associated keywords in which activity units or short messages are identified and placed in an appropriate category. In various embodiments, categories are subject or topic containers that include, but are not limited, to a person, place or thing. Keywords extracted from short messages that are relevant to a category are associated with the corresponding category. In one embodiment, keywords are provided by advertisers or syndicators. For every message, a score is assigned to the message for each category. A search query for information on a specific topic can identify the best message or messages by identifying the appropriate category and utilizing the best scored messages for the identified category in conjunction with an amount of keywords that match between the message and the query. In one embodiment, a search query is initiated by an activity API from a participating site, a participating user, and/or the activity server.

### Categories and Keywords

Categories of interest are generated by identifying a specific subject or topic, such as a person, place, or an object. In one embodiment, the categories are generated and/or established by the activity server. The categories in one embodiment are refined based on usage performance. In particular, categories focused on things perform well with narrower descriptions having a better performance. For example, a category such as “sports” would not perform as well as “basketball,” which would not perform as well as “UCLA basketball.” These fine grained categories however can come at the cost of increased processing time and storage. In one embodiment, each category is unique having no overlap with other categories.

For each category generated, one or more keywords are identified and associated with each category. In one embodiment, keywords are stored in tables in which each category may have multiple tables. The keywords that are stored come from messages in the desired medium. As such, in one embodiment, within each category, there is a specific table with one or more specific keywords for each medium. Each medium, e.g., messaging service, can have different message formats and/or terminology used. For example, text messages from a mobile phone can and will often look quite different from messages posted to FACEBOOK. Thus, keywords from other sources in one embodiment are only used as a search query into the desired message format. In this way, the keyword tables would account for slang terms and other such differentiators specific to the medium. One or more of the following processes can be used to identify the keywords.

### Unambiguous Training

For a given category, e.g., musical artists, there can be ambiguous and unambiguous terminology. For example, an artist name can be ambiguous (“the Beatles”) or unambiguous (“Paul McCartney”). Utilizing unambiguous terminology, every keyword used in a message containing “Paul McCartney” would be stored, and the usage frequencies of the keywords would be used as a measure of how related to the musical artist category a given query would be.

### User Tagging

A message database in one embodiment would allow for manual tagging of information. These tags are created by users as a means to self-classify messages. One example is preceding a tag name with a unique character, e.g., a “#” character. For example, if a message contains “#oscars”, then presumably the message is about the Oscars awards ceremony. As such, keywords about the Oscars awards ceremony can be generated by finding every message with the “#oscars” tag, and store each of the keywords present in the located messages. The resulting table would thus include words commonly used to describe the ceremony, and thus using the table a message that did not have a “#oscars” tag could still be located.

### Third-Party Information

In one embodiment, a third party database or similar resource can be used to identify keywords. For example, utilizing a resource, such as Wikipedia, as a large collection of words related to a category, a TF-IDF analysis of this resource would yield the most important keywords for a given category. Messages could be searched to locate messages that used these keywords in which each of the resulting message-based keywords are stored in the associated category's table.

### Category and Message Scoring

A message score for a given category is a measure of how likely its keywords are present in all the messages related to the category. The message scores are defined by

$$score ( m , c ) = {\sum }_{g ∈ m} f ( P ( g , c ) )$$

where m is a given message, c is a given category, g is a keyword in the message, and P(g,c) is the normalized frequency of a message in category c containing the keyword g. The function f is a thresholding or quantization function.

### Quantization Function f

Most category tables have probability distributions that follow a power-law distribution. However, the resulting tables may have a large number of small values, or conversely, a small number of large values. In such cases, it may be helpful to pass this table through a quantization function. The simplest function is simply a threshold, by which any keywords that do not pass the threshold have frequencies set to 0. More complex quantizers are used to simplify the table, boost certain values, or otherwise be shaped to improve the scoring performance.

A final message score is defined as w_{score}·score(m, c_{q})+w_{match} match(m, q), where w is a weight [0 . . . 1], score(m, c_{q}) is the score of the message in the query's category, and match(m, q) is the percentage of keywords that match between message m and the query q. This value is used to ensure that the messages have some similarity, even if they both score high in each category.

Referring now to an example, if the query is “Amazon river,” then this query would rank high in a category about rivers, the Amazon jungle, or even geographical categories. This query however would score lower in categories about companies, as the term “river” would not occur very frequently in these categories. Similarly, the message “Hiked to the Amazon today—what a beautiful jungle this is” would also rank high in the category of geographical messages, as the keywords “hiked” and “jungle” would appear often in such categories. Finally, the message matches 50% of the terms in the query (i.e., “Amazon”), ensuring that the message has a relation to the query and not just the category as a whole.

In one embodiment, a message classifier server is in network communication with the activity server and is coupled with a message database. In one embodiment, the message classifier is integrated with the activity server and/or the message database is integrated with the activity database. The message classifier/activity server is in network communication with a plurality of messaging services and information sources. The message classifier server receives user generated messages from the plurality of messaging services and information sources. The received messages are stored in category records in the message database and keywords are selected from the received messages and associated with the category records. The message classifier server also scores each message that is stored in the message database and associated with the corresponding category records.

The message classifier server also receives search queries externally from, for example, messaging services or web servers or internally, for example, through a user interface in communication with the message classifier server. For each received search query, the message classifier server calculates a score that identifies a specific category. Utilizing the score, the server retrieves the associated category record from the message database. Messages stored or associated with the category record is retrieved by the server and transmitted back to a designated recipient, e.g., the sender of the search query. In one embodiment, the message classifier server calculates or retrieves a final message score for the identified category for the stored messages. Utilizing the final message score, the server selects specific messages stored or associated with the category record for transmission to a designated recipient.

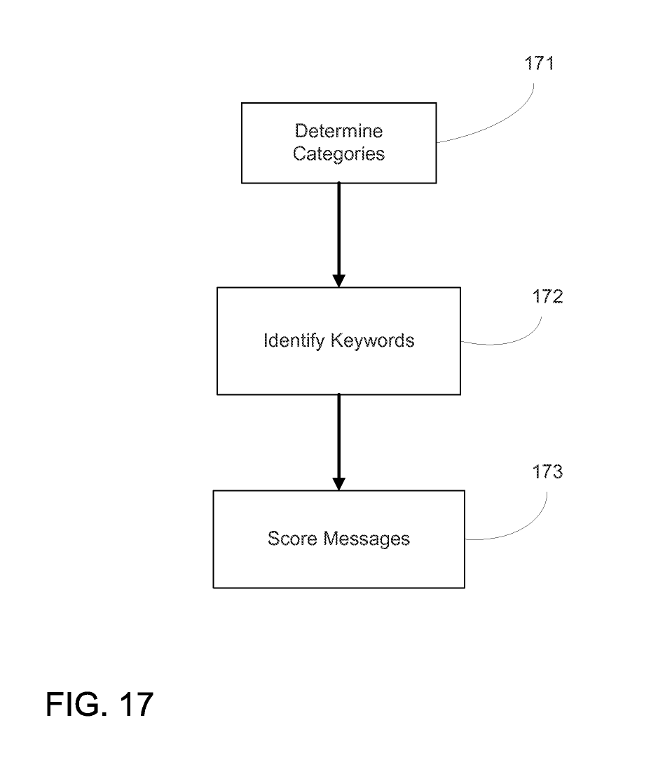

In FIG. 17, a messaging classification generation process in accordance with various embodiments of the invention is illustrated. Initially, categories are first determined (171). Keywords are identified and used to populate tables for each determined category (172). In one embodiment, a medium is identified and used to select tables in which to populate with the keywords identified. Each message received is scored for each determined category (173).

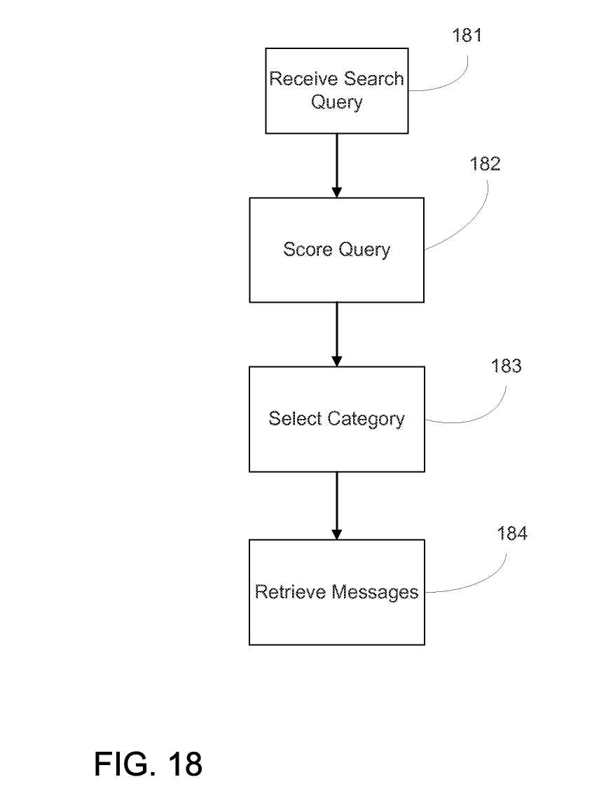

Referring now to FIG. 18, a messaging classification retrieval process starts with a search query being received (181). The query is scored for each category (182) and the category with the highest query score is selected (183). Messages with the highest score in this category and that contain some of the matched terms are returned as the message search results (184). In one embodiment, terms or words are extracted from the query and matched to keywords for the determined category.

Referring back to the “Amazon river” query example, two potential categories are established. It would be appreciated that the number of categories may be varied and numerous along with the associated keywords and messages, but are shown here in a limited fashion to facilitate the description of the invention. The first category is a geographical location category and the second category is a company category. As shown in the following tables, each category includes a set of keywords with associated normalized keyword frequency calculations.

TABLE 2
Company

| Normalized Keyword | |
|---|---|
| Frequency | Keywords |
| 0.5 | revenue |
| 0.2 | employee |
| 0.01 | Amazon |
| . . . | . . . |
| 0.0005 | jungle |
| 0.0001 | hike |

TABLE 1
Geographical Location

| Normalized Keyword | |
|---|---|
| Frequency | Keywords |
| 0.2 | river |
| . . . | . . . |
| 0.05 | jungle |
| 0.05 | Amazon |
| 0.005 | hike |

Utilizing the tables and in particular matching the keywords of each category with the terms in the search query, a query score is determined utilizing the associated normalized keyword frequency calculations. For example, the query score for the geographical location category is 0.25 (0.2 (river)+0.05 (Amazon)). Likewise, the query score for the company category is 0.01 (0.01 (Amazon)+0 (river)).

Given a first message, “Hiked to the Amazon today, what a beautiful jungle this is” and a second message, “Amazon announced revenue up 38%,” messages scores can also be generated by matching keywords for each category and utilizing the associated normalized keyword frequency calculations. For example, the message score for the first message in the geographical category is 0.105 (0.05 (jungle)+0.05 (Amazon)+0.005 (hike)) and in the company category is 0.0106 (0.01 (Amazon)+0.0005 (jungle)+0.0001 (hike)). The second message score for the geographical category is 0.05 (Amazon) and for the company category 0.51 (0.5 (revenue)+0.01 (Amazon)).

Since the query score for the geographic category (0.25) is higher or larger than the query score for the company category (0.1), the geographic location category is selected to utilize the message scores for each of the messages. Thus, score (m1, geographic)=0.105 and score (m2, geographic)=0.05, where m1 and m2 are respective first and second messages. Since in the provided example, the search query is short, only one term matches, i.e., Amazon. Thus, the match values for each message are match(m1, q)=0.5 and match(m2, q)=0.5, where q is the query. Accordingly, the final score disregarding weight factors shows that the first message has a final score of 0.605 (0.105+0.5) greater than the final score of 0.55 (0.05+0.5) for the second message. Thus, the first message being the most relevant is provided as the search result for the given search query.

Referring again to FIG. 14, in one embodiment, an optimizer is integrated with or coupled to the activity server to refine the search results provided by the message classifier (143). The optimizer utilizes a plurality of criteria to further refine the activities to provide the best overall match of user generated activities to a user, an advertiser, a publisher, and/or a syndicator. The search results are then distributed by the activity server (144).

The optimizer measures both relevance and quality of the activity. The relevance in one embodiment is based on a lexical match between the activity and the publisher context. Advertising keywords can also be used to enhance the match. Activity quality is a function of a plurality of different measurements. Such measurements include but are not limited to freshness, viralness, categories, popularity, social connection (e.g., social graph distance), location (physical distance of user relative to the activity), content (e.g., well written or relevance (stays on the subject, provides details about subject)) and other identifiers utilized to better match the search results to the search query and/or the requestor.

FIG. 15 illustrates an activity social network system in accordance with various embodiments of the invention in which syndicators 151 and advertisers 152 provide user activity data to the activity server 153. The advertisers can provide advertising keywords while the syndicators can provide data feeds from a collection of multiple sources. A datastore 154 provides an activity database that stores all of the supplied activity data to the activity server. In one embodiment, data is also gathered or collected by using meta information from the syndicating, publishing, and/or advertising sites. Meta information may be automatically generated by crawling through one or more of these sites and performing keyword extraction and/or capturing a site's semantic information. The activity server includes or is integrated with a message classifier and/or an optimizer 157.

In one embodiment, the activity server includes or is incorporated with an extraction tool 155. The extraction tool performs a normalization of user activities. For example, for each activity, a date/time, user id, URL, verb, object type, object heading, and object body can be extracted. With the extracted information, a message can be generated in which the extracted information is arranged into a sentence like structure determined by a presentation template 156. One such example follows:

Trent posted an entry titled “The Slip CD/DVD available now” on 7:26 pm Jul. 21, 2008 at nin.com, where Trent is the user id, posted is the verb, entry is the object type and “The Slip CD/DVD available now” is the object heading, 7:26 pm Jul. 21, 2008 being the date/time and nin.com being the URL. The presentation template in one embodiment provides the extraction tool the ability to customize the message to a particular medium or based on a publishers' presentation criteria relative to the activity. The messages to be published by the publisher's websites 158 are then cached 159 for use by these sites upon request of the APIs of these sites.

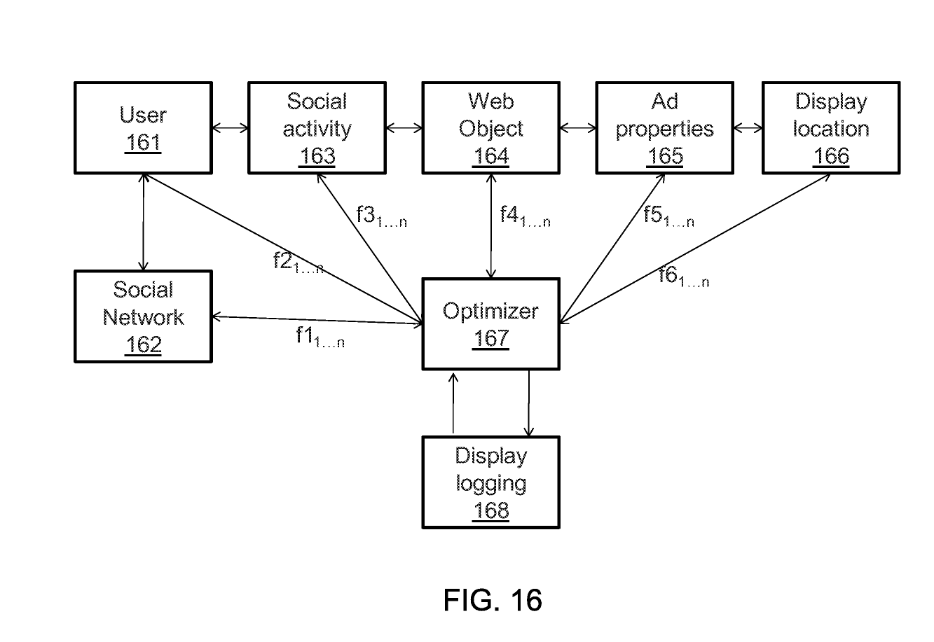

Referring now to FIG. 16, as shown, in one embodiment the activity network builds taxonomy of users, activities, and the subject of their activities. In the illustrated example, a user 161 is part of a social network 162 and performs activities 163. The subject of those activities is an object 164 on the web (like a web page and its contents, a multimedia file, etc.) Similarities between the web object and an advertisement 165 and/or the advertisement and the desired display location 166 of the activity unit are determined by the optimizer 167.

The optimizer balances the number of inputs, or features (f1-f6), from each of these components in concert. The features of each are considered independently, but weighted jointly. Some features are the output of the classifiers discussed earlier. As users engage with the display units, their actions are logged (168) and fed back into the optimizer. The optimizer then adjusts the relative weights and properties of each feature to determine an optimal performance profile.

It should be appreciated that some or all of the processes and/or functionalities or features described throughout the application could be implemented through software, firmware, hardware, or any combination thereof. Also, while the above description contains many specific embodiments of the invention, these should not be construed as limitations on the scope of the invention, but rather as an example of one embodiment thereof. Furthermore, all the functionality and specific layouts illustrated in the figures and/or described herein should not be construed as essential to the invention or as limitations on the scope of the invention, but rather as an example of one embodiment thereof. Accordingly, the scope of the invention should be determined not by the embodiments illustrated, but by the appended claims and their equivalents.

What is claimed is:

1. A method of syndicating relevant user activities, the method comprising:
obtaining a first advertising bid from a first advertising site using an activity server coupled to a network, where an advertising bid comprises metadata describing categories of user activities;
obtaining a second advertising bid from a second advertising site using the activity server;
recording user activities with a first participating site using the activity server;
classifying the recorded user activities using the activity server, where the classified user activity comprises metadata describing at least one category associated with the recorded user activity;
determining an auction strategy based on the first advertising bid, the second advertising bid, the first advertising site, and the second advertising site using the activity server, where the auction strategy selects at least one winning advertising site;
generating an ad unit ad unit comprising metadata describing the recorded user activity and the at least one winning advertising site using the activity server; and
syndicating the generated ad unit to at least one participating site within an advertisement network using the activity server.

2. The method of claim 1, further comprising:
obtaining registration request data using the activity server, where the registration request data identifies a web server;
providing an activity application programming interface to the identified web server; and
incorporating the identified web server into the advertisement network.

3. The method of claim 2, further comprising registering the identified web server as a participating web server using the activity server.

4. The method of claim 3, further comprising:
obtaining termination request data comprising a participating web server in the advertisement network using the activity server; and
removing the participating web server from the advertisement network based on the termination request data using the activity server.

5. The method of claim 1, further comprising:
obtaining user registration request data using the activity server; and
authorizing user of an activity application programming interface based on the user registration request data using the activity server.

6. The method of claim 5, further comprising logging activity data describing activities participated in by the user associated with the user registration request data using the activity server.

7. The method of claim 6, wherein the logged activity data described activities performed on a third party service distinct from the advertisement network.

8. The method of claim 7, further comprising obtaining the logged activity data from the third party service via an application programming interface using the activity server.

9. The method of claim 6, wherein the logged activity data described activities performed on a participating site within the advertisement network.

10. The method of claim 6, wherein the logged activity data is anonymized such that the user performing the activity data described in the logged activity data cannot be determined.

11. The method of claim 6, wherein generating an ad unit further comprises:
identifying when a user of a participating web site is an authorized user;
generating the ad units based on the logged activity data when the user is an authorized user; and
generating the ad units based on a set of default advertising data when the user is not an authorized user.

12. The method of claim 1, further comprising tracking interactions with the syndicated ad units on the participating web sites using the activity server.

13. The method of claim 12, further comprising:
identifying an origination site from which an ad unit in the syndicated ad units originated from using the activity server, where the ad unit comprising advertising data and advertising fee data;
identifying the participating web site on which the tracked interactions with the ad unit occurred using the activity server;
determining a first portion of the advertising fee data to be allocated to the origination site based on the tracked interactions using the activity server;
determining a second portion of the advertising fee data to be allocated to the participating web site based on the tracked interactions using the activity server;
determining a third portion of the advertising fee data to be allocated to the activity server based on the tracked interactions using the activity server.

14. The method of claim 13, wherein the third portion of the advertising fee data is further based on the first portion of the advertising fee data.

15. The method of claim 13, wherein the advertising fee data describes a fee determined by the origination site to be paid to a participating web site in response to an interaction with the ad unit.

16. The method of claim 13, further comprising enforcing a minimum advertising fee for an ad unit based on the tracked interactions using the activity server.

17. The method of claim 1, wherein the advertising strategy further comprises:
when the second advertising bid is greater than then first advertising bid, obtain a third advertising bid from the first advertising site using the activity server, where the third advertising bid is greater than the second advertising bid; and
when the third advertising bid exceeds the second advertising bid, selecting the first advertising site as the winning advertising site using the activity server.

18. The method of claim 17, wherein the advertising strategy further comprises:
associating a first discount with the first advertising site using the activity server; and
determining the value of the third advertising bid based on a third bid value provided by the first advertising site and the first discount using the activity server.

19. The method of claim 1, wherein the advertising strategy further comprises:
when the second advertising bid exceeds the first advertising bid, determining an ad unit sharing fee between the first advertising site and the second advertising site based on the recorded user activity using the activity server;
selecting the second advertising site as the winning advertising site using the activity server; and
transmitting the ad unit sharing fee to the first advertising site based on user interactions with the ad unit on a participating site using the activity server, where the ad unit is provided to the participating site by the second advertising site.

20. The method of claim 1, wherein the advertising strategy further comprises:
when the first advertising bid is greater than the second advertising bid, selecting the first advertising site as the winning advertising site using the activity server; and
when the second adverting bid is greater than the first advertising bid, selecting the second advertising site as the winning advertising site using the activity server.

21. The method of claim 1, wherein:
the user activity is associated with a first user; and
the participating site is configured to display the generated ad unit to a participate site user distinct from the first user associated with the user activity.

22. The method of claim 1, further comprising presenting the user activities to the first advertising site and the second advertising site to solicit bids based on a matching algorithm using the activity server.

23. The method of claim 1, further comprising providing the generated ad units to the participating site based on the advertising site associated with the generated ad unit, the participating site, and a matching algorithm using the activity server.

24. The method of claim 1, wherein the generated ad unit is based on a presentation template.

25. The method of claim 24, wherein the generated ad unit includes a portion of the recorded user activities and presentation criteria provided by the advertising site associated with the generated ad unit.

26. An activity server, comprising:
a processor; and
a memory connected to the processor;
wherein the processor is configured to:
obtain a first advertising bid from a first advertising site, where an advertising bid comprises metadata describing categories of user activities;
obtain a second advertising bid from a second advertising site;
record user activities with a first participating site;
classify the recorded user activities, where the classified user activity comprises metadata describing at least one category associated with the recorded user activity;
determine an auction strategy based on the first advertising bid, the second advertising bid, the first advertising site, and the second advertising site, where the auction strategy selects at least one winning advertising site;
generate an ad unit ad unit comprising metadata describing the recorded user activity and the at least one winning advertising site; and
syndicate the generated ad unit to at least one participating site within an advertisement network.
